(19) United States
(12) Patent Application Publication
(10) Pub. No.: US 2008/0024377 A1
(43) Pub. Date: Jan. 31, 2008

(54) SIGNALING IN FIRST AND SECOND FREQUENCY RANGES

(75) Inventor: Ralph Prestros, Wels (AT)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Neubiberg (DE)

(21) Appl. No.: 11/828,780

(22) Filed: Jul. 26, 2007

(30) Foreign Application Priority Data
Jul. 26, 2006 (DE) 10 2006 034 559.2

(51) Int. Cl. H01Q 1/00

(52) U.S. Cl. 343/722

(57) ABSTRACT

An antenna arrangement for receiving and sending signals in a first frequency range and in a second frequency range, the antenna arrangement including at least two antenna elements configured to receive and send signals in the first frequency range and a connecting arrangement to which at least two of the antenna elements can be electrically connected in series.

### CROSS-REFERENCE TO RELATED APPLICATION

This application claims priority to German Patent Application Serial No. 102006034559.2, which was filed Jul. 26, 2006, and is incorporated herein by reference in its entirety.

### FIELD OF THE INVENTION

The invention relates to an antenna arrangement and a method for receiving and sending signals in a first frequency range and in a second frequency range.

### BACKGROUND OF THE INVENTION

Antenna arrangements are coupling elements or converters which are used in radio engineering in order to convert electromagnetic waves into electrical signals and vice versa. Depending on the frequency of the electromagnetic wave and the space available for the antenna arrangement, different conversion principles are used.

In the ultra high frequency band (UHF) at frequencies from 300 MHz to 3 GHz, the wavelengths λ are 10 cm to 1 m. It is therefore possible to use antennas with dimensions which are in the order of magnitude of the wavelength λ. A widely used antenna for this frequency band is the folded dipole, which is also called a loop dipole and is shown in FIG. 1. A first connection node A1 and a second connection node A2 in the centre of the folded dipole A are used to supply it with an AC voltage, or can be used to tap off the voltage induced in it by an electromagnetic wave. The length L and the width D of the folded dipole A are chosen such that the latter is resonant for frequencies in the frequency range which is to be converted. In general, this is the case when the length L=V*λ/2 and the width D<0.05λ, where λ is the wavelength and V is a velocity factor.

One variant of the folded dipole is what is known as the quadrature dipole, whose length and width are L=D=V*λ/2. A circular antenna having a diameter of V*λ/2, in this case called circular dipole, may likewise be used instead of a folded dipole in order to convert signals in this frequency range. In the text below, the term “first frequency range” means the UHF band, inter alia.

In the shortwave range (SW), at frequencies from 3 to 30 MHz and wavelengths λ from 10 m to 100 m, the large wavelengths and the associated large dimensions mean that folded dipoles can no longer be designed to be resonant. Hence, frame antennas are preferably used which comprise one or more coils and, in the extreme near field, are based on a principle of inductive coupling, that is to say which work in a similar manner to loosely coupled transformers. If these antennas are etched from or printed onto flexible printed circuit boards then they are also referred to as magnetic antennas. In this case, the voltage induced in the frame antenna is proportional to the frequency, the number of turns and the area enclosed by the coil. At a frequency of 13.56 MHz, numbers of turns from 1 to 10 are sufficient. In the text below, the term “second frequency range” means the SW frequency band, inter alia.

For radio-frequency identifier (RFID) tags, which are used to identify articles and can be read wirelessly, certain frequency ranges are released under the name ISM (Industrial, Scientific, Medical). At frequencies f=13.56 MHz, the transmission takes place through inductive coupling, and at f=2.4 GHz, dipoles at resonance are typically used. The frequencies f=13.56 MHz and f=2.4 GHz are available worldwide. Depending on availability, or received signal level it is desirable to be able to receive signals from the first frequency range and the second frequency range using a single antenna. A problem of such dual band antennas is that if the antenna is in the form of a folded dipole for the first frequency range then signals in the second frequency range can be converted only ineffectively, since only a single turn is provided. Conversely, antennas which have been optimized for the second frequency range cannot be used advantageously for converting signals in the first frequency range. One solution is to provide two different antennas, respectively optimized for just one of the two frequency ranges, and to switch between them on the basis of the frequency. However, the increased space requirements and the higher costs make such a solution unsatisfactory.

### SUMMARY OF THE INVENTION

An antenna arrangement for receiving and sending signals in a first frequency range and in a second frequency range, where the antenna arrangement includes at least two antenna elements configured to receive and send signals in the first frequency range, and a connecting arrangement with which at least two of the antenna elements can be electrically connected in series.

### BRIEF DESCRIPTION OF THE DRAWINGS

The text below provides a more detailed explanation of the invention using exemplary embodiments with reference to the figures, in which:

FIG. 1 shows a known folded dipole,

FIG. 2 shows a first exemplary embodiment of an antenna arrangement based on the invention when converting signals in the second frequency range,

FIG. 3 shows a first exemplary embodiment of an antenna arrangement based on the invention when converting signals in the first frequency range, and

FIG. 4 shows a second exemplary embodiment of an antenna arrangement based on the invention when converting signals in the first and in the second frequency range.

### DETAILED DESCRIPTION OF THE INVENTION

The invention specifies an antenna arrangement for receiving and sending signals in a first frequency range and a second frequency range, which has high conversion efficiency in both frequency ranges and requires little space. In addition, the invention specifies an associated method for receiving and sending signals in a first frequency range and a second frequency range.

The invention includes an antenna arrangement for receiving and sending signals in a first frequency range and in a second frequency range, where the antenna arrangement includes at least two antenna elements for receiving and sending signals in the first frequency range, and a connecting arrangement with which at least two of the antenna elements can be electrically connected in series.

At least two antenna elements optimized for receiving and sending signals in the first frequency range are used. The connecting arrangement can be used for electrically connecting at least two of these antenna elements in series. In this case, an antenna element is an arrangement capable of conversion, such as a turn on a magnetic antenna or a folded dipole.

In one embodiment, signals in the second frequency range are received and sent by virtue of at least two of the antenna elements being connected in series by the connecting arrangement.

The electrical series connection of the antenna elements allows an improvement in the conversion properties of the antenna arrangement for signals in the second frequency range.

In one embodiment, signals in the first frequency range are received and sent using just one of the antenna elements.

One of the antenna elements, which are optimized for converting signals in the first frequency range, is sufficient to convert signals in the first frequency range with a high level of efficiency as a complete antenna. The connecting arrangement connects the antenna elements accordingly.

In one embodiment, signals in the first frequency range are received and sent by virtue of at least two of the antenna elements being electrically connected in parallel by the connecting arrangement.

The parallel connection of two or more antenna elements allows the connection resistance of the antenna arrangement, also called base resistance or antenna resistance, to vary and to match itself to the line resistance of the line to which the antenna arrangement is connected.

In one embodiment, the antenna elements for receiving and sending signals in the first frequency range are folded dipoles, quadrature dipoles or circular dipoles which have at least one resonant frequency in the first frequency range.

Folded dipoles, whose length is proportional to the wavelength, are particularly suitable for converting signals which have wavelengths in the first frequency range.

In one embodiment, the antenna elements for receiving and sending signals in the first frequency range are geometrically no further away from one another than 0.01 times the average wavelength of the first frequency range.

The fact that the antenna elements are arranged in a geometric proximity to one another which is less than 0.01 times the average wavelength of the first frequency range, that is to say much less than the width D of the folded dipole, means that the parallel-connected antenna elements act as a single folded dipole with a large conductor track width, if the antenna elements are in the form of conductor tracks.

In one embodiment, the first frequency range is in the ultra high frequency band or the longwave range of the centimeter wave band.

Ultra high frequencies can be converted particularly effectively by folded dipoles. In particular, the frequencies in the first frequency range are around 2.4 GHz, which are used to operate RFID tags. The centimeter wave band extends from 3 GHz to 30 GHz.

In one embodiment, the second frequency range is in the shortwave band.

The series connection of the antenna elements results in a larger number of turns in the antenna arrangement than in the case of a single folded dipole, which means that the antenna arrangement acts with a similar level of efficiency in the shortwave band as a frame antenna or magnetic antenna. In particular, the frequencies in the second frequency range are around 13.56 MHz, which are used to operate RFID tags.

In one embodiment, the antenna arrangement has a first connection node and a second connection node, the antenna elements each have a first connection node and a second connection node, the antenna elements can each have their first connection node connected to the first connection node of the antenna arrangement via a respective first switch, the antenna elements can each have their second connection node connected to the second connection node of the antenna arrangement via a respective second switch, the second connection node of each antenna element can be connected to the first connection node of another antenna element via the respective second switch and via the respective first switch of the other antenna element, in the case of precisely one of the antenna elements the first connection node is not connected to the first connection node of the antenna arrangement via a respective first switch but rather is connected to it directly, and in the case of precisely another of the antenna elements the second connection node is not connected to the second connection node of the antenna arrangement via a respective second switch but rather is connected to it directly.

The antenna elements are connected in series and parallel via the first switch and the second switch, which are parts of the connecting arrangement. If all the first switches and second switches are in a first switch position, the antenna elements are electrically connected in series. If, by contrast, all the first switches and second switches are in a second switch position, the antenna elements are electrically connected in parallel. The first and second switches can thus be used to select in what frequency range the antenna arrangement is to be operated.

In one embodiment, the first switches and the second switches are transistors.

Transistors can be integrated easily into the chips or integrated circuits of the RFID tags and actuated on the basis of the frequencies to be converted.

In one embodiment, the antenna arrangement has a first connection node and a second connection node, the antenna elements each have a first connection node and a second connection node, the antenna elements each have their first connection node connected to the first connection node of the antenna arrangement via a respective first filter element, the antenna elements each have their second connection node connected to the second connection node of the antenna arrangement via a respective first filter element, the second connection node of each antenna element is connected to the first connection node of another antenna element via a respective second filter element, in the case of precisely one of the antenna elements the first connection node is not connected to the first connection node of the antenna arrangement via a respective first filter element but rather is connected to it directly, and in the case of precisely another of the antenna elements the second connection node is not connected to the second connection node of the antenna arrangement via a respective first filter element but rather is connected to it directly, and the second connection node is not connected to the first connection node of another antenna element via a second filter element.

The connecting device which can be used for electrically connecting the antenna elements in series or parallel can also be implemented using first and second filter elements instead of switches. An advantage of this embodiment is that signals from the first frequency range and the second frequency range can be simultaneously sent and/or simultaneously received.

In one embodiment, the first filter elements pass signals in the first frequency range and reject signals in the second frequency range.

Signals in the first frequency range are thus forwarded from the connection nodes of the antenna arrangement via the first filter elements in parallel to the connection nodes of the antenna elements, so that the antenna elements are connected in parallel. Signals in the second frequency range are not passed, which means that the antenna elements are not shorted when operated with signals in the second frequency range, but rather can be connected to one another in series.

In one embodiment, the second filter elements pass signals in the second frequency range and reject signals in the first frequency range.

Signals in the second frequency range are passed by the second filter elements, so that the antenna elements are connected to one another in series. By contrast, signals in the first frequency range are rejected, so that the antenna elements are not shorted to one another by the first and second filter elements.

The invention includes a method for receiving and sending signals in a first frequency range and in a second frequency range, where signals in the second frequency range are received and sent by electrically connecting a plurality of antenna elements for receiving and sending signals in the first frequency range in series.

The series connection of the antenna elements makes it possible to increase the number of turns for converting signals in the second frequency range, so that the signals are converted with a higher level of efficiency.

In one embodiment, signals in the first frequency range are received and sent using just one of the antenna elements.

Since the antenna elements are designed for receiving and sending signals in the first frequency range, one of the antenna elements is sufficient to convert signals in the first frequency range with a high level of efficiency.

In one embodiment, signals in the first frequency range are received and sent by electrically connecting a plurality of antenna elements in parallel.

The connection resistance of the antenna arrangement can be matched to the line resistance of the connecting lines by the number of antenna elements which are connected in parallel.

The inventive antenna arrangement and the inventive method are used in radio-frequency identification tags (RFID tags).

FIG. 2 shows a first exemplary embodiment of an antenna arrangement based on the invention. The antenna arrangement has a first connection node A1 and a second connection node A2 and comprises a plurality of antenna elements A. By way of example, four antenna elements A are shown here, it naturally also being possible to use a different number of antenna elements A.

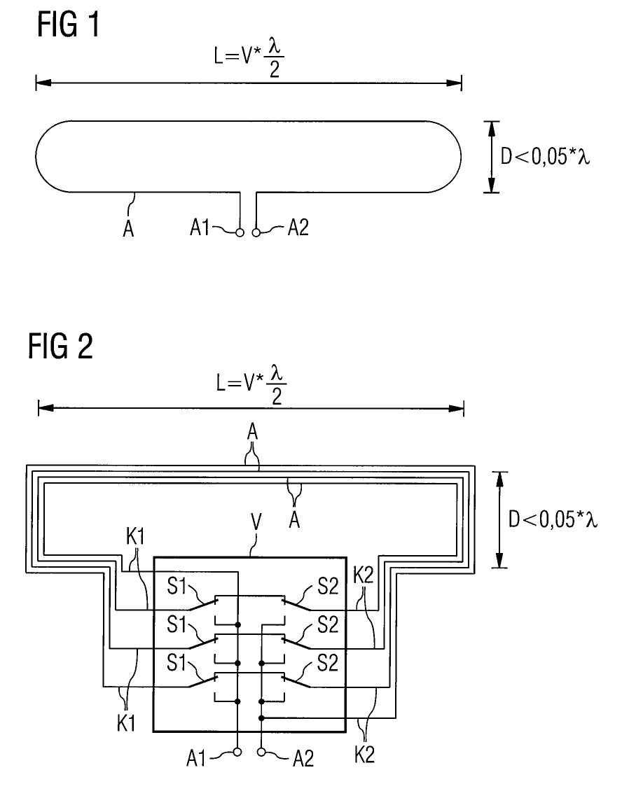

Each antenna element A has a first connection node K1 and a second connection node K2. The dimensions of the antenna elements A correspond to those of the folded dipole shown in FIG. 1, that is to say that they are optimized for converting signals having a wavelength of λ. The dimensions of the antenna elements A slightly differ from one another, with the average antenna element size corresponding to that of the folded dipoles. So that the antenna elements A act in the first frequency range like a folded dipole with a larger conductor track width when converted as appropriate, they are geometrically situated so close together that the distances between the antenna elements A are negligibly short in comparison with the width D of the dipoles. By way of example, the antenna elements can be printed on to a flexible support body, as are used for RFID tags, for example, using screen printing or photolithographic methods. Instead of the rectangular shape shown, they may also be oval, as shown in FIG. 1, or have similar shapes.

The connecting arrangement V connects the first and second connection nodes A1 and A2 of the antenna arrangement to the first and second connection nodes K1 and K2 of the antenna elements A. One of the antenna elements A, the innermost one in FIG. 2, has its first connection node K1 connected directly to the first connection node A1 of the antenna arrangement, and another antenna element A, the outermost one in FIG. 2, has its second connection node K2 connected directly to the second connection node K2 of the antenna arrangement. The remaining connection nodes K1 and K2 of the antenna elements A can either be connected via a respective first switch S1 and a second switch S2 to another connection node K2 and K1 of another antenna element A, or can be connected via a respective first switch S1 or second switch S2 to one of the connection nodes A1 and A2 of the antenna arrangement.

The antenna arrangement can be operated with signals in a first frequency range and a second frequency range, depending on the switch position of the first and second switches S1 and S2. In one embodiment, for operation in the first frequency range a frequency of 13.56 MHz is provided, and a frequency around 2.4 GHz is provided for operation in the second frequency range, as are used by RFID tags.

FIG. 2 shows the antenna arrangement when converting signals in the second frequency range. The three first switches S1 and three second switches S2 are in a first switch position and connect the antenna elements A in series. A signal which is present on the first connection node A1 of the antenna arrangement is routed to the first connection node K1 of the innermost antenna element A and is transmitted by means of the latter to its second connection node K2. There, the signal flows via a second switch S2 to the first connection node K1 of another antenna element A. This is repeated for the remaining antenna elements A until the signal is connected to the second connection node A2 of the antenna arrangement via the second connection node K2 of the outermost antenna element A. The series connection of the antenna element A increases the number of turns, so that the antenna arrangement now works as a frame antenna or magnetic antenna. In this case, the number of turns is prescribed by the number of antenna elements A. If the second frequency range is in the shortwave band, the inventive antenna arrangement can be used to achieve a higher level of conversion efficiency than with just one antenna element A.

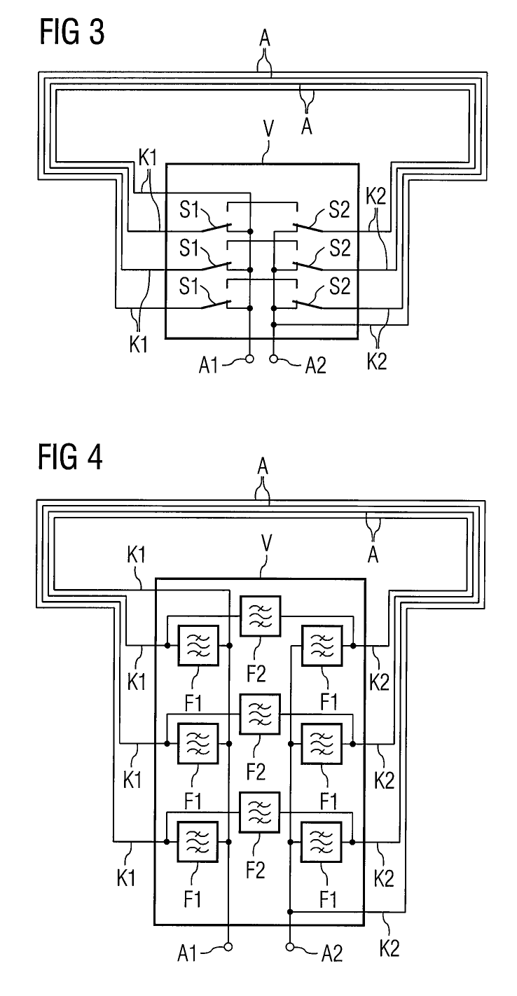

FIG. 3 shows the same antenna arrangement as FIG. 2, but when converting signals in the first frequency range. All the first switches S1 and the second switches S2 are now in a second switch position. All four antenna elements A now have their first connection node K1 and their second connection node K2 connected to the first connection node A1 or the second connection node A2 of the antenna arrangement. If the first frequency range is in the ultra high frequency band or the longwave range of the centimeter wave band, each of the antenna elements A converts the frequency used with a high level of efficiency in line with its design as a folded dipole.

As an alternative to the arrangement shown, it is also possible for not all the antenna elements A to be electrically connected in parallel with one another but rather for just a portion thereof or the antenna arrangement to be operated even just with one antenna element A. The connecting arrangement V must in this case be modified such that the first switches S1 and second switches S2 also have a switch position in which the first connection nodes K1 and second connection nodes K2 of the relevant antenna element A are not connected. The electrical parallel connection of the antenna elements A allows the connection resistance between the first connection node A1 and second connection node A2 of the antenna arrangement to be varied and hence to be matched to the resistance of the supply lines for the antenna arrangement. Using the first exemplary embodiment shown in FIGS. 2 and 3, it is possible, depending on the switch position of the first switches S1 and the second switches S2, to convert signals either in the first frequency range or in the second frequency range with just one antenna arrangement.

FIG. 4 shows a second exemplary embodiment of an antenna arrangement based on the invention. The arrangement and design of the antenna elements A correspond to those in the first exemplary embodiment, but with the connecting arrangement V being implemented with first filter elements F1 and second filter elements F2 instead of switches. The antenna elements A respectively have their first connection node K1 and their second connection node K2 connected to the first connection node A1 and to the second connection node A2 of the antenna arrangement via a respective first filter element F1. The second connection node K2 of each antenna element A is also connected to the first connection node K1 of a respective other antenna element A via a respective second filter element F2. However, in the case of precisely one of the antenna elements A the first connection node K1 is connected to the first connection node A1 of the antenna arrangement only directly and equally in the case of precisely one other of the antenna elements A the second connection node K2 is connected to the second connection node A2 of the antenna arrangement only directly. The first filter elements F1 pass signals in the first frequency range and reject signals in the second frequency range, while the second filter elements F2 pass signals from the second frequency range and reject signals from the first frequency range.

If a signal from the first frequency range is now present between the first connection node A1 and the second connection node A2 of the antenna arrangement, this signal is passed by the first filter elements F1, so that the antenna elements A are electrically connected in parallel with the first connection node A1 and the second connection node A2. The connection via the second filter elements F2 between the first connection node K1 of an antenna element A and the second connection node K2 of a further antenna element A is interrupted, since the second filter elements F2 reject signals from the first frequency range. By omitting individual first filter elements F1, one of the antenna elements A can again be excluded from the parallel connection, so that this arrangement also can be used to set the resistance between the first connection node A1 and the second connection node A2 of the antenna arrangement.

If a signal, which is in the second frequency range is applied to the first connection node A1 and the second connection node A2 of the antenna arrangement, the first filter elements F1 reject and isolate all but two of the antenna connection nodes K1 and K2 from the connection nodes A1 and A2 of the antenna arrangement, Since the signal is forwarded by the second filter elements F2, series connection of the antenna elements A is obtained. A first connection node K1 of an antenna element A is connected to the second connection node K2 of another antenna element A via a respective second filter element F2 in this case. Depending on the signal frequency present on the first connection node A1 and on the second connection node A2 of the antenna arrangement, the antenna elements A in the antenna arrangement shown in FIG. 4 are electrically connected in series or parallel. The filter elements F1 and F2 allow simultaneous reception of signals from the first frequency range and the second frequency range. In addition, the actuation of the first and second switches S1 and S2 in the first exemplary embodiment can be dispensed with.

What is claimed is:

1. An antenna arrangement for receiving and sending signals in a first frequency range and in a second frequency range, comprising:
at least two antenna elements configured to receive and send signals in the first frequency range; and
a connecting arrangement with which at least two of the antenna elements can be electrically connected in series.

2. The antenna arrangement as claimed in claim 1, wherein signals in the second frequency range are received and sent by virtue of at least two of the antenna elements being connected in series by the connecting arrangement.

3. The antenna arrangement as claimed in claim 1, wherein signals in the first frequency range are received and sent using only one of the antenna elements.

4. The antenna arrangement as claimed in claim 1, wherein signals in the first frequency range are received and sent by virtue of at least two of the antenna elements being electrically connected in parallel by the connecting arrangement.

5. The antenna arrangement as claimed in claim 1, wherein the antenna elements configured to receive and send signals in the first frequency range are folded dipoles, quadrature dipoles or circular dipoles which have at least one resonant frequency in the first frequency range.

6. The antenna arrangement as claimed in claim 1, wherein the antenna elements configured to receive and send signals in the first frequency range are located no further from one another than 0.01 times the average wavelength of the first frequency range.

7. The antenna arrangement as claimed in claim 1, wherein the first frequency range is in the ultra high frequency band or in the longwave range of the centimeter wave band.

8. The antenna arrangement as claimed in claim 1, wherein the second frequency range is in the shortwave band.

9. The antenna arrangement as claimed in claim 1, further comprising a first connection node and a second connection node, and the antenna elements each have a first connection node and a second connection node,
wherein:
the antenna elements can each have their respective first connection node connected to the first connection node of the antenna arrangement via a respective first switch,
the antenna elements can each have their respective second connection node connected to the second connection node of the antenna arrangement via a respective second switch,
the second connection node of each antenna element can be connected to the first connection node of another antenna element via the respective second switch and via the respective first switch of the other antenna element,
in the case of precisely one of the antenna elements the first connection node is connected directly to the first connection node of the antenna arrangement, and
in the case of precisely another of the antenna elements the second connection node is connected directly to the second connection node of the antenna arrangement.

10. The antenna arrangement as claimed in claim 1, wherein the first switches and the second switches are transistors.

11. The antenna arrangement as claimed in claim 1, further comprising a first connection node and a second connection node, and the antenna elements each have a first connection node and a second connection node,
wherein:
the antenna elements each have their first connection node connected to the first connection node of the antenna arrangement via a respective first filter element,
the antenna elements each have their second connection node connected to the second connection node of the antenna arrangement via a respective first filter element,
the second connection node of each antenna element is connected to the first connection node of another antenna element via a respective second filter element,
in the case of precisely one of the antenna elements the first connection node is connected directly to the first connection node of the antenna arrangement, and
in the case of precisely another of the antenna elements the second connection node is connected directly to the second connection node of the antenna arrangement, and the second connection node is not connected to the first connection node of another antenna element via a second filter element.

12. The antenna arrangement as claimed in claim 11, wherein the first filter elements pass signals in the first frequency range and reject signals in the second frequency range.

13. The antenna arrangement as claimed in claim 11, wherein the second filter elements pass signals in the second frequency range and reject signals in the first frequency range.

14. A method for receiving and sending signals in a first frequency range and in a second frequency range, comprising receiving and sending signals in the second frequency range by electrically connecting in series a plurality of antenna elements configured to receive and send signals in the first frequency range.

15. The method as claimed in claim 14, further comprising receiving and sending signals in the first frequency range using exactly one of the antenna elements.

16. The method as claimed in claim 14, further comprising receiving and sending signals in the first frequency range by electrically connecting a plurality of antenna elements in parallel.

17. The method as claimed in claim 14, wherein the antenna elements are in a form of folded dipoles, quadrature dipoles or circular dipoles which have at least one resonant frequency in the first frequency range.

18. The method as claimed in claim 14, wherein the antenna elements are located no further away from one another than 0.01 times the average wavelength of the first frequency range.

19. The method as claimed in claim 14, wherein the first frequency range is in the ultra high frequency band or in the longwave range of the centimeter wave band.

20. The method as claimed in claim 14, wherein the second frequency range is in the shortwave band.

21. The method as claimed in claim 14, wherein the antenna elements are electrically connected by transistors.

22. The method as claimed in claim 14, wherein the antenna elements are connected by first filter elements and second filter elements.

23. The method as claimed in claim 22, further comprising:
the first filter elements passing signals in the first frequency range and rejecting signals in the second frequency range; and
the second filter elements passing signals in the second frequency range and rejecting signals in the first frequency range.

24. An antenna arrangement for receiving and sending signals in a first frequency range and in a second frequency range, comprising:
at least two antenna means for receiving and sending signals in the first frequency range; and
a connecting means for electrically connecting at least two of the antenna elements in series.
